(19) United States
(12) Patent Application Publication
(10) Pub. No.: US 2026/0336091 A1
(43) Pub. Date: Oct. 29, 2026

(54) Portable Handheld Tool Organizer

(71) Applicant: Cullen Groome, Douro Dummer (CA)

(72) Inventor: Cullen Groome, Douro Dummer (CA)

(21) Appl. No.: 19/560,397

(22) Filed: Mar. 9, 2026

Related U.S. Application Data
(60) Provisional application No. 63/774,934, filed on Mar. 20, 2025.

(51) Int. Cl. B25H 3/06; B60R 11/06

(52) U.S. Cl. CPC B25H 3/06; B60R 11/06

(57) ABSTRACT

A portable handheld tool organizer is disclosed. The portable handheld tool organizer includes a bracket including a base plate and a wall extending upwardly from the base plate. The portable handheld tool organizer includes a pair of guide rails secured to the wall and arranged spaced apart from one another to define opposing rail surfaces. The portable handheld tool organizer includes a tray slidably engaged with the pair of guide rails and configured to translate along a width direction of the wall between retracted and extended positions. The tray is arranged substantially parallel to the wall and is configured to support one or more handheld power tools and manual tools in a vertical orientation when in use. A system for storing handheld power tools and manual tools within a vehicle compartment is also disclosed.

### BACKGROUND OF THE INVENTION

### 1. Technical Field

The present subject matter, in general, relates tool organizers and storage systems, and more particularly relates to a portable tool organizer suitable to be arranged inside a trailer or truck compartment to mount and store a plurality of tools including power tools and manual tools.

### 2. Description of the Prior Art

Storing and accessing tools within service vehicles, trailers, and on-site work environments presents ongoing challenges for professional technicians. Power tools and manual tools are often transported loosely or in conventional tool bags, bins, or storage boxes that require a user to open lids, sort through stacked items, or move multiple containers to reach specific tools. This arrangement slows deployment, increases handling time, and creates inefficiencies during situations where rapid access to equipment is essential, such as emergency field operations or time-sensitive construction tasks.

In addition to accessibility issues, existing transport methods frequently fail to protect tools from impact, abrasion, and wear caused by vibration and movement during vehicle travel. Tools stored in traditional bags or containers may shift, collide, or bounce within the storage area, leading to premature degradation, broken accessories, or damage to housings and batteries. Conditions are particularly challenging in mobile environments such as rescue trucks, utility vehicles, or contractor vans where tools must remain stable despite road conditions, sudden stops, or off-road motion.

Various storage systems have been proposed to organize tools, but many remain bulky, difficult to relocate, or poorly suited for rapid, one-handed deployment. Conventional shelving systems secure tools in fixed positions but lack portability, while portable kits often require users to lift heavy containers or search through disorganized compartments. Accordingly, there is a need for a storage solution that improves tool accessibility, reduces wear during transportation, and enables fast, reliable deployment of essential equipment. A system that combines mobility with structured vertical organization would address longstanding shortcomings in field tool management.

Therefore, in light of foregoing discussions, there is a need to overcome the limitations and disadvantages related to conventional tool organizers, and to provide portable, simple and easily accessible handheld tool organizer suitable to be arranged inside a trailer or truck compartment to mount and store a plurality of power tools.

### SUMMARY OF THE INVENTION

Some embodiments of the present subject matter provide a handheld tool organizer is disclosed. The portable organizing solution for power tools and manual tools can offer distinct advantages over traditional bags, bins, and boxed containers by eliminating the need to dig through cluttered compartments or remove multiple lids just to access essential equipment. By supporting tools in a structured upright arrangement and allowing quick retrieval with minimal handling, it reduces the time spent locating specific items during urgent or high-pressure tasks. Its stable, vibration-resistant configuration helps prevent wear and damage that typically occur when tools bounce or collide during vehicle travel. At the same time, its lightweight, easily deployable construction allows users to remove and carry the entire unit to a remote job site or emergency scene, enabling faster, more efficient preparation compared to bulky, non-portable shelves or disorganized storage totes.

In an aspect, the present subject matter provides a portable handheld tool organizer. The portable handheld tool organizer includes a bracket including a base plate and a wall extending upwardly from the base plate. The portable handheld tool organizer includes a pair of guide rails secured to the wall and arranged spaced apart from one another to define opposing rail surfaces. The portable handheld tool organizer includes a tray slidably engaged with the pair of guide rails and configured to translate along a width direction of the wall between retracted and extended positions. The tray is arranged substantially parallel to the wall and is configured to support one or more handheld tools in a vertical orientation when in use.

In another aspect, the present subject matter provides a system for storing handheld tools within a vehicle compartment. The system includes a vehicle-mounted attachment structure disposed within an interior compartment of a vehicle, and a portable handheld tool organizer removably coupled to the attachment structure. The portable handheld tool organizer includes a bracket including a base plate and a wall extending upwardly from the base plate. The portable handheld tool organizer includes a pair of guide rails secured to the wall and arranged spaced apart from one another to define opposing rail surfaces. The portable handheld tool organizer includes a tray slidably engaged with the pair of guide rails and configured to translate along a width direction of the wall between retracted and extended positions. The tray is arranged substantially parallel to the wall and is configured to support one or more handheld tools in a vertical orientation when in use. The bracket is removable from the attachment structure to permit portable deployment of the organizer outside the vehicle.

These and other features, aspects, embodiments, and advantages of the present subject matter will be better understood with reference to the following description and appended claims. This summary is provided to introduce a selection of concepts in a simplified form. This summary is not intended to identify key features or essential features of the claimed or disclosed subject matter, nor is it intended to be used to limit the scope of the claimed subject matter.

### BRIEF DESCRIPTION OF FIGURES

The summary above, as well as the following detailed description of illustrative embodiments, is better understood when read in conjunction with the appended drawings. For the purpose of illustrating the present subject matter, exemplary constructions of the subject matter are shown in the drawings. However, the present subject matter is not limited to specific methods and instrumentalities disclosed herein. Moreover, those in the art will understand that the drawings are not to scale. Wherever possible, like elements have been indicated by identical numbers.

Embodiments of the present subject matter will now be described, by way of example only, with reference to the following diagrams wherein:

FIG. 1A is a perspective view of a portable handheld tool organizer, in accordance with an embodiment;

FIG. 1B is a front view of the portable handheld tool organizer, in accordance with an embodiment; and

FIG. 2 is an illustration of a system for storing handheld tools within a vehicle compartment.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

In overview, some embodiments of the present subject matter relate to storing power tools and manual tools in a portable handheld tool organizer. The following detailed description illustrates various embodiments of the present subject matter and ways in which they can be implemented. Although some modes of carrying out the present subject matter have been disclosed, those skilled in the art would recognize that other embodiments for carrying out or practicing the present subject matter are also possible. Some disclosed embodiments include portable handheld tool organizer have been disclosed herein.

Example embodiments are described below with reference to the accompanying drawings. Unless otherwise expressly stated in the drawings, the sizes, positions, etc., of components, features, elements, etc., as well as any distances therebetween, are not necessarily to scale, and may be disproportionate and/or exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one element could be termed a “first element” and similarly, another element could be termed a “second element,” or vice versa. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the figures. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or to other orientations) and the spatially relative descriptors used herein may be interpreted accordingly.

Unless clearly indicated otherwise, all connections and all operative connections may be direct or indirect. Similarly, unless clearly indicated otherwise, all connections and all operative connections may be rigid or non-rigid.

Many different forms and embodiments are possible without deviating from the spirit and teachings of this disclosure and so this disclosure should not be construed as limited to the example embodiments set forth herein. Rather, these example embodiments are provided so that this disclosure will be thorough and complete, and will convey the scope of the disclosure to those skilled in the art.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

In an aspect, some embodiments of the present subject matter provide a portable handheld tool organizer.

The portable handheld tool organizer includes:
a bracket including a base plate and a wall extending upwardly from the base plate;
a pair of guide rails secured to the wall and arranged spaced apart from one another to define opposing rail surfaces; and
a tray slidably engaged with the pair of guide rails and configured to translate along a width direction of the wall between retracted and extended positions,
   wherein the tray is arranged parallel to the wall and is configured to support one or more handheld tools in a vertical orientation when in use.

In another aspect, some embodiments of the present subject matter provide a system for storing handheld tools within a vehicle compartment.

The system includes:
a vehicle-mounted attachment structure disposed within an interior compartment of a vehicle; and
a portable handheld tool organizer removably coupled to the attachment structure, the organizer comprising:
   a bracket including a base plate and a wall extending upwardly from the base plate;
   a pair of guide rails secured to the wall and arranged spaced apart from one another; and
   a tray slidably supported by the pair of guide rails and configured to translate along a width direction of the wall between retracted and extended positions,
   wherein the tray is arranged parallel to the wall and is configured to support one or more handheld tools in a vertical orientation when in use,
   and wherein the bracket is removable from the attachment structure to permit portable deployment of the organizer outside the vehicle.

### Definitions

Bracket functions as a structural support assembly that unifies the base plate and the wall into a rigid framework. The bracket provides stability for components that attach or slide relative to it. The bracket may be shaped or configured to bear loads imposed by tools and accessories supported by the organizer. The bracket also serves as the interface point for optional mounting mechanisms used in a vehicle or other environment.

Base plate base plate acts as a lower support surface that forms the foundation of the organizer. The base plate may be generally planar and sized to rest securely on a surface or integrate with a mounting interface. The base plate may provide storage or placement areas for additional items such as batteries. The base plate also contributes to the structural integrity of the assembly by supporting the wall.

Wall is an upright panel extending from the base plate that provides a vertical structure for mounting additional components. The wall may extend along a width dimension sufficient to support rails, grooves, or trays. The wall offers lateral stability and defines the plane against which the tray moves. The wall may include surface features such as grooves that enhance handling or connection.

Guide rails guide rails are elongated structural members secured to the wall to define a controlled sliding pathway. The guide rails are spaced apart so that they collectively form opposing surfaces that guide motion of the tray. The guide rails keep the tray aligned during translation to prevent unintended detachment. The guide rails may be shaped or angled to form slots for receiving ends of the tray.

Opposing rail surfaces represent the inward-facing regions of the guide rails that constrain lateral movement of the tray. The opposing rail surfaces define the functional boundary within which the tray travels. The opposing rail surfaces may help maintain consistent alignment throughout the full range of sliding motion. By facing toward each other, they cooperatively form a channel that stabilizes tray engagement.

Tray serves as a movable support platform that carries tools or accessories. The tray translates along the width direction of the wall while remaining generally parallel to the wall. The tray may include openings or features that enable gripping or sliding by a user. The tray provides a structured surface that orients tools in a consistent vertical arrangement.

The phrase slidably engaged describes a condition where two components interact through a guided mechanical pathway that permits smooth linear movement. This engagement allows the tray to travel relative to the guide rails without disengaging. The sliding interaction is constrained so that motion occurs primarily along one axis. The arrangement maintains positional stability while enabling extension and retraction.

Width direction of the wall refers to the lateral axis extending across the wall's horizontal dimension. It corresponds to the direction in which the tray moves while being guided by the rails. This direction is perpendicular to the thickness of the wall. It is also generally parallel to the upper edge of the wall.

The retracted position is a state in which the tray is located closer to the wall or within the bounds of the structural members. In this state, the tray occupies minimal outward space. It is used during storage or stowing to protect the tray and the tools it supports. The retracted position helps prevent accidental interference with surrounding objects.

The extended position is a state in which the tray is displaced outwardly away from the wall to increase accessibility. This outward motion exposes supported tools for easier retrieval. The extended position may be manually achieved by pulling on a handle or groove. It represents the operational state for tool access or deployment.

Vertical orientation refers to an arrangement where the primary length or axis of a tool is aligned upward and downward relative to gravity. This orientation helps reduce space requirements and improves visibility of tool handles. Positioning tools vertically can also minimize wear from bouncing during transport. It provides consistent organization that supports rapid, intuitive retrieval.

Elongated groove is a lengthwise recess formed through a component to facilitate gripping or handling. The shape allows a user's fingers to naturally engage and lift the unit. This feature may be located near an upper portion of the structure for ergonomic access. It can also reduce overall weight by eliminating unnecessary material.

Handle structure is a formed region designed to permit manual grasping of the unit. It provides leverage for carrying, lifting, or repositioning the organizer. This structure may take the form of a groove, opening, or shaped contour. Its placement enhances portability and reduces strain during transport.

First plate is a primary planar portion of a guide rail that attaches directly to the wall. It provides a stable base from which the second plate extends. The first plate contributes to forming a boundary of the slot that receives the tray ends. It can be sized to distribute loads applied during sliding.

Second plate is a planar segment extending from the first plate and spaced from the wall to form a passage. Its relationship with the first plate defines the geometry of a slot that guides tray movement. The second plate may run parallel to the wall for alignment stability. Its spacing allows the tray to engage the guide rails while maintaining clear sliding motion.

Elongated slot is a lengthwise opening defined between portions of the guide rail and the wall. It receives the corresponding ends of the tray to maintain guided translation. The slot extends along the length sufficient to permit full movement of the tray. It stabilizes the tray against undesired rotation or lateral shifting.

An L-shaped rail includes two plates or segments that meet at approximately a right angle to form a channel structure. An inverted L-shaped configuration mirrors the orientation of the first to create a complementary channel on the opposite side. When used together, these shapes create facing slots that engage a tray on both sides. Their geometry helps control motion and prevent upward or downward dislodging.

Opposite longitudinal ends refer to the two farthest spaced points along the main length of the tray. These ends interface with the corresponding slots in the guide rails. Their engagement ensures the tray remains aligned during sliding movement. They also distribute loads evenly across the guide rail system.

The lateral end of the tray is the side edge extending across its width dimension. This region may include a handle groove or similar feature for pulling the tray outward. Access at this end helps users initiate sliding movement. Its positioning ensures ease of operation even when the tray is fully retracted.

Attachment structure is a mechanical interface used to secure the organizer within a compartment. It may include rails, brackets, slots, hooks, or other coupling elements. The structure allows reversible installation so the unit can be removed when required. It ensures stable support during vehicle movement or vibration.

The phrase vertically adjustable describes a configuration permitting movement of the organizer upward or downward relative to a support frame. This adjustment allows users to optimally position the unit for accessibility. It may be achieved through sliding engagement, slots, or lift-assist elements. The capability improves usability across different vehicle layouts.

Vehicle-mounted attachment structure is a fixed installation point located inside a vehicle for supporting the organizer. It withstands forces produced during vehicle travel. The structure aligns the organizer securely while allowing removal when desired. It helps integrate the system into specialized service, rescue, or utility vehicles.

Illumination module is a lighting device incorporated into the unit to enhance visibility. It may be powered by batteries or a connected electrical source. The module assists in low-light or night operations by illuminating the surrounding area. Its presence improves safety and accuracy when retrieving tools.

Battery storage area is a designated region for placing or retaining rechargeable cells. It helps users keep essential tool batteries organized and immediately available. This area may include features that prevent movement during vehicle travel. It also supports quick deployment by keeping power supplies within reach.

The proposed portable handheld tool organizer provides a significant effectiveness over conventional techniques such as traditional bags, bins, and boxed containers that require the user to dig through piled equipment or remove multiple lids just to locate a specific tool. By presenting tools in an upright, visually exposed arrangement, it eliminates the inefficiencies associated with rummaging through stacked items and helps users quickly identify and retrieve exactly what is needed. This configuration also reduces the time and physical effort required during emergency responses, service calls, or rapid-deployment scenarios where seconds often matter. Furthermore, by providing defined positions for each tool, it improves consistency, minimizes misplacement, and enhances overall situational readiness compared to lose storage solutions.

In addition to accessibility benefits, the structured layout provides superior protection for tools during vehicle travel compared to conventional soft bags or open containers, which allow tools to shift, collide, and suffer wear from constant vibration. The organized and stabilized positioning helps reduce impact-related damage, battery detachment, and unnecessary wear on tool housing and attachments. The ability to remove the entire unit and deploy it directly at a job site or emergency scene adds portability that fixed shelving systems cannot offer, while avoiding the bulk and weight associated with large portable cases. This combined mobility and stability makes the solution particularly effective for technicians, rescue teams, and field operators who need both rapid deployment and reliable protection from transport-induced damage.

These and other features, aspects, embodiments, and advantages of the present subject matter will be better understood with reference to the below-stated description and appended claims. These definitions are provided to introduce a selection of concepts in a simplified form. These definitions are not intended to identify key features or essential features or keywords of the claimed or disclosed subject matter, nor are they intended to be used to limit the scope of the claimed subject matter.

The portable handheld tool organizer as disclosed in this document is described in detail by way of examples and with reference to the figures. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, etc., may be made and may be desired for a specific application.

In the present subject matter, any identification of specific shapes, materials, techniques, arrangements, etc., is either related to a specific example presented or is merely a general description of such a shape, material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to FIGURES.

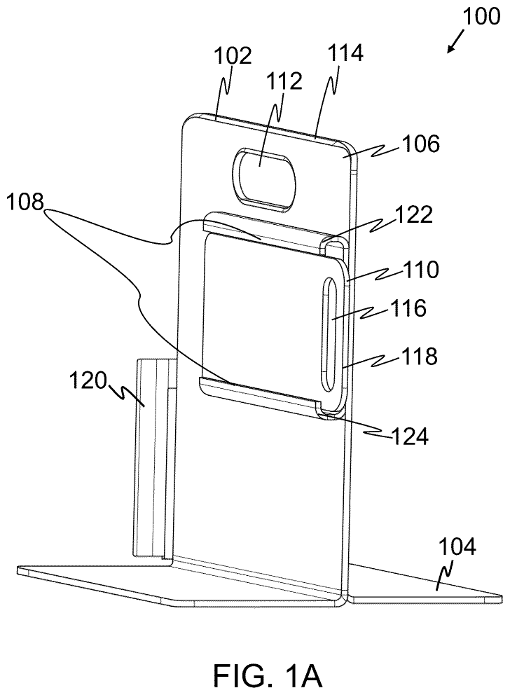

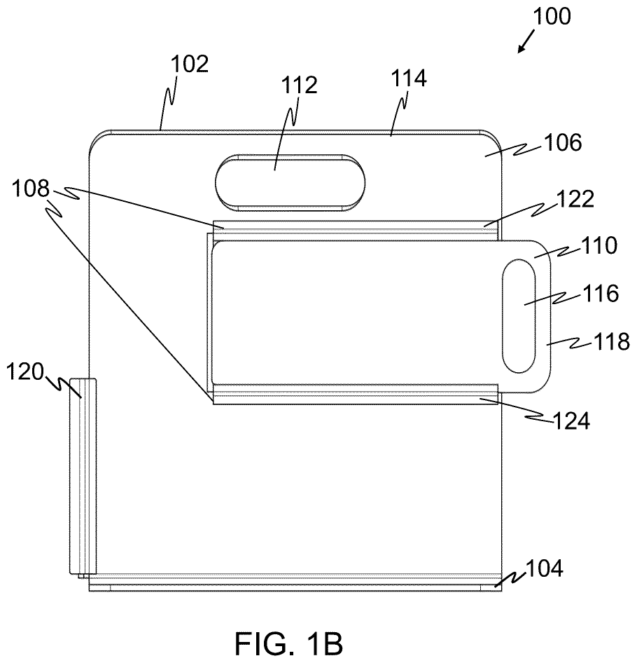

FIG. 1A is a perspective view of a portable handheld tool organizer 100, in accordance with an embodiment. FIG. 1B is a front view of the portable handheld tool organizer 100, in accordance with an embodiment. The portable handheld tool organizer 100 includes a bracket 102 including a base plate 104 and a wall 106. The portable handheld tool organizer 100 includes a pair of guide rails 108. The portable handheld tool organizer 100 includes a tray 110. The wall 106 includes an elongated groove 112 proximate an upper end 114 of the wall 106. The tray 110 includes a handle groove 116 extending through the thickness of the tray proximate a lateral end 118 of the tray 110. The portable handheld tool organizer 100 also includes an attachment structure 120. Each of the pair of guide rails 108 includes a first plate 122 and a second plate 124.

In some embodiments, the bracket 102 includes the base plate 104 that forms a foundational support surface and the wall 106 that extends upwardly from the base plate 104 to provide a vertically oriented structural member for mounting additional components. The base plate 104 may be generally planar and sized to rest on or engage with a supporting surface, while the wall 106 may span substantially across the width of the base plate 104 to enhance stability and alignment. The upward extension of the wall 106 allows it to serve as a central interface for attaching guiding structures, retention features, or sliding mechanisms used to support and position tools. Together, the base plate 104 and the wall 106 form a rigid framework that supports the overall operation of the organizer and facilitates proper arrangement and accessibility of tools during storage, transport, and deployment.

In some embodiments, the wall 106 includes an elongated groove 112 positioned proximate to an upper end 114 of the wall 106 to provide a handle structure for carrying the portable handheld tool organizer 100. The elongated groove 112 may extend laterally across a portion of the wall 106 to allow a user's fingers to comfortably enter and grasp the organizer 100 with a secure hold. Positioning the elongated groove 112 near the upper end 114 enables ergonomic lifting by reducing the amount of bending or wrist rotation required during transport. This handle structure allows the organizer 100 to be carried easily as a single integrated unit, even when fully loaded with handheld tools or accessories.

In some embodiments, the pair of guide rails 108 are secured to the wall 106 and are positioned in a spaced-apart manner so that their inward-facing surfaces collectively define opposing rail surfaces that guide the motion of a sliding component. The guide rails 108 may extend along at least a portion of the width of the wall 106 to provide a stable and elongated sliding interface. Their spacing and orientation help maintain the alignment of a movable tray and prevent unintended lateral or vertical displacement during operation. The arrangement of the guide rails 108 on the wall 106 thus establishes a controlled pathway that supports reliable and repeatable translational movement throughout the full range of travel.

In some embodiments, the pair of guide rails 108 are disposed proximate the upper end 114 of the wall 106 relative to the base plate 104 and extend along a width of the wall 106 to provide an elevated and elongated support interface for a sliding component. Positioning the guide rails 108 near the upper end 114 allows the sliding mechanism to remain stable and aligned even when supporting the weight of one or more handheld power tools and manual tools. The widthwise extension of the guide rails 108 ensures that the sliding pathway spans a substantial portion of the wall 106, thereby distributing mechanical loads more evenly along the structure. This arrangement enhances the smoothness, reliability, and structural rigidity of the sliding interaction, particularly during repeated extension and retraction cycles in demanding field environments.

In some embodiments, each of the pair of guide rails 108 includes a first plate 122 attached to the wall 106 and a second plate 124 arranged parallel to the wall 106 and spaced from the wall 106 to define an elongated slot sized to receive portions of the tray 110. The first plate 122 provides a rigid structural base that secures the guide rail 108 to the wall 106, ensuring stability and proper alignment along the width of the organizer 100. The second plate 124 extends outwardly from the first plate 122 and forms a spaced, parallel surface that cooperates with the wall 106 to create a channel-like geometry for guided sliding movement. The relative spacing of the second plate 124 from the wall 106 determines the thickness and clearance of the elongated slot, thereby enabling smooth, controlled engagement of the tray 110 while minimizing lateral play or rotational movement during use.

In some embodiments, the pair of guide rails 108 includes a first one of the guide rails 108 formed with an L-shaped geometry and a second one of the guide rails 108 formed with an inverted L-shaped geometry, thereby defining a first elongated slot 122 and a second elongated slot 124 that face each other across the wall 106. The complementary shapes of these guide rails 108 create opposing, mirror-image channels that cooperatively receive and constrain the longitudinal ends of the tray 110 during sliding movement. This opposing arrangement enhances the stability of the tray 110 by restricting upward, downward, and lateral displacement throughout its travel path. The mirrored slot configuration further allows the tray 110 to remain fully supported even when extended outwardly, improving the overall durability and reliability of the portable handheld tool organizer 100 during repeated operation.

In some embodiments, the portable handheld tool organizer 100 includes a second pair of guide rails secured to a side of the wall 106 opposite the pair of guide rails 108, with a second tray slidably supported by the second pair of guide rails and arranged parallel to the wall 106. This dual-sided configuration provides two independent sliding platforms, allowing tools to be stored on both sides of the wall 106 while maintaining balanced weight distribution. The arrangement enables users to organize different categories of handheld power tools and manual tools on opposing trays, improving accessibility and reducing clutter within a vehicle compartment or job-site environment. Additionally, supporting multiple trays on opposite sides enhances storage capacity without significantly increasing the overall footprint of the organizer 100, thereby maximizing functional efficiency in constrained spaces.

In some embodiments, the tray 110 is slidably engaged with the pair of guide rails 108 and is configured to translate along a width direction of the wall 106 between retracted and extended positions. The engagement between the tray 110 and the guide rails 108 establishes a controlled sliding interface that allows the tray 110 to move smoothly while remaining properly aligned relative to the wall 106. This guided movement enables the tray 110 to be selectively extended outward for access to stored tools and retracted inward for compact storage within the confines of the organizer. The sliding functionality provided by the guide rails 108 allows the tray 110 to transition between operational states without tilting or disengaging, thereby ensuring stable support for handheld power tools and manual tools throughout its range of motion.

In some embodiments, the tray 110 is arranged parallel to the wall 106 so that its primary supporting surface remains in consistent alignment with the vertical plane defined by the wall 106. This parallel orientation ensures that the tray 110 maintains a stable and predictable relationship with the guide rails 108, which in turn helps prevent tilting, sagging, or rotational movement during use. By remaining closely aligned with the wall 106, the tray 110 can extend and retract smoothly along the defined sliding pathway without binding or lateral deviation. The parallel arrangement also maximizes usable space within the organizer by allowing the tray 110 to operate within a compact footprint while still providing sufficient surface area to support a range of handheld power tools and manual tools.

In some embodiments, the tray 110 includes opposite longitudinal ends that are received within the elongated slots defined by the guide rails 108 to establish a stable and reliable sliding engagement. The insertion of these longitudinal ends into the elongated slots ensures that the tray 110 remains properly aligned during translation along the width direction of the wall 106, preventing tilting or disengagement during movement. This slot-based engagement distributes mechanical loads evenly across the guide rails 108, allowing the tray 110 to support the weight of one or more handheld power tools and handheld tools without excessive lateral play. The interaction between the tray 110 and the elongated slots created by the guide rails 108 therefore provides controlled, low-friction, and repeatable sliding motion between retracted and extended positions.

In some embodiments, the tray 110 includes the handle groove 112 extending through the thickness of the tray 110 and positioned proximate to a lateral end 118 to facilitate manual operation. The handle groove 112 provides an accessible gripping region that allows a user to apply pulling or pushing force directly to the tray 110, thereby enabling smooth transition between retracted and extended states. Locating the handle groove 112 near the lateral end 118 improves leverage and reduces the physical effort required to initiate movement, even when the tray 110 is loaded with tools. Additionally, the through-thickness design of the handle groove 112 accommodates various hand sizes and grip styles, contributing to ergonomic handling during deployment in field service, job-site, or emergency response environments.

In some embodiments, the portable handheld tool organizer 100 includes an attachment structure 120 configured to removably mount the portable handheld tool organizer 100 within an interior compartment of a vehicle. The attachment structure 120 may be secured to a wall, ceiling, support frame, or other structural region of the vehicle to provide a stable interface capable of withstanding vibration, acceleration forces, and motion associated with vehicle travel. This configuration enables the organizer 100 to remain securely positioned during transport, while still allowing the user to detach it quickly when portable deployment is needed at a remote job site or emergency location. The removable nature of the attachment structure 120 provides flexibility for repositioning, storage optimization, and rapid tool access in demanding field environments.

In some embodiments, the bracket 102 is slidably mounted to the attachment structure 120 and is vertically adjustable relative to the attachment structure 120 to position the bracket 102 within the compartment. This sliding engagement allows the organizer 100 to be raised or lowered to accommodate varying vehicle layouts, user preferences, or accessibility requirements. The vertical adjustment mechanism may include detents, slots, rails, or locking features that allow the bracket 102 to maintain a selected height during operation and transport. By enabling controlled vertical positioning, the attachment structure 120 enhances ergonomic tool retrieval, ensures compatibility with multiple compartment geometries, and improves overall integration of the organizer 100 into diverse vehicle platforms.

In these embodiments, the tray 110 is configured to support one or more handheld power tools and manual tools in a vertical orientation, allowing each tool to be suspended or positioned with its length generally aligned along an up-and-down direction. Supporting tools in this manner helps reduce the amount of horizontal space required for storage and allows users to quickly identify and retrieve the desired tool without disturbing adjacent equipment. The vertical arrangement can also help minimize wear or damage during transport by limiting unintended movement or contact between tools as a vehicle travel over uneven surfaces. Furthermore, this configuration enhances visibility and accessibility, enabling efficient deployment in field environments such as emergency response scenarios, construction sites, or service operations where speed and clarity of organization are critical.

In some embodiments, the portable handheld power tool organizer 100 includes an adjustable mounting interface configured to receive tool holders or accessories at multiple selectable positions. The adjustable mounting interface enables users to tailor the arrangement of both powered and manual tools according to their operational needs, tool dimensions, and preferred access patterns. By offering multiple receiving points for tool holders, the interface supports customization that enhances usability across different working environments such as job sites, emergency response scenes, and vehicle-mounted service applications. This configuration also allows the organizer 100 to evolve with the user's equipment changes, ensuring long-term versatility.

In some embodiments, the adjustable mounting interface includes a grid-pattern arrangement of holes, slots, or attachment points configured to allow customizable placement of tool holders. The grid-pattern arrangement may extend across a portion of the wall 106, the base plate 104, or both, providing a structured matrix into which tool holders may be inserted, repositioned, or removed without tools. Such a pattern accommodates a wide variety of tool geometries and accessory designs, enabling the user to achieve a secure and ergonomic layout. The grid-pattern arrangement also allows incremental fine-tuning of tool positions, ensuring optimal use of space while maintaining accessibility and stability during transport and deployment.

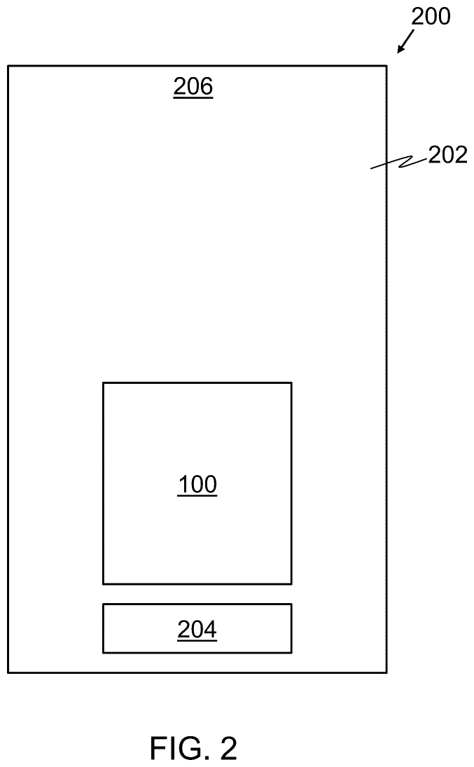

FIG. 2 is an illustration of a system 200 for storing handheld power tools and manual tools within a vehicle compartment 202, in accordance with an embodiment. The system 200 includes a vehicle-mounted attachment structure 204 disposed within an interior compartment of a vehicle 206. The system 200 includes the portable handheld tool organizer 100 as illustrated in FIG. 1A and FIG. 1B. The system 200 includes the vehicle-mounted attachment structure 204 disposed within an interior compartment of the vehicle 206, where the vehicle-mounted attachment structure 204 is positioned to provide a stable interface capable of withstanding vibration, acceleration, and road-induced motion. In the depicted arrangement, the vehicle compartment 202 may be formed by a sidewall, bulkhead, frame rail, or other interior structural member of the vehicle 206, and the vehicle-mounted attachment structure 204 may be secured thereto using fasteners, welded brackets, rails, or interlocking hardware compatible with the vehicle interior. The vehicle-mounted attachment structure 204 is located to facilitate both secure retention of stored equipment during transit and convenient access when the vehicle 206 is stationary, thereby enabling practical deployment in service, construction, or emergency response scenarios.

The system 200 further includes the portable handheld tool organizer 100, as illustrated in FIG. 1A and FIG. 1B, removably coupled to the vehicle-mounted attachment structure 204. In some embodiments, the portable handheld tool organizer 100 engages the vehicle-mounted attachment structure 204 through complementary coupling features that allow the portable handheld tool organizer 100 to be installed and removed without specialized tools, while maintaining a firm connection during vehicle operation. The coupling may accommodate vertical adjustability of a bracket of the portable handheld tool organizer 100 to align the portable handheld tool organizer 100 at a user-selected height within the vehicle compartment 202 for ergonomic retrieval of tools. In use, the portable handheld tool organizer 100 may be detached from the vehicle-mounted attachment structure 204 and transported as a single unit to a job site or emergency scene, providing a direct transition from in-vehicle storage to field deployment without repacking or rearranging equipment.

In some embodiments, the base plate of the portable handheld tool organizer 100 defines a battery storage area configured to receive one or more rechargeable batteries. This battery storage area may include recessed regions, contoured pockets, or retention features that help maintain each battery in a stable position during transportation and handling. By providing a dedicated location on the base plate, the organizer 100 allows users to keep essential power sources readily available and organized alongside the tools they support, reducing the need to search through separate bins or containers. The defined battery storage area also enhances safety and durability by minimizing the movement, impact, or abrasion that batteries might otherwise experience when transported loosely within a vehicle compartment or work environment.

In some embodiments, the portable handheld tool organizer 100 includes an illumination module configured to provide light during night operations at an emergency scene or job site. The illumination module may be integrated into the organizer 100 at a position that casts light on the tray, the surrounding work area, or both, enabling clear visibility during low-light or no-light conditions. This feature supports effective tool retrieval and deployment in situations where external lighting is insufficient, ensuring that users can operate efficiently and safely regardless of environmental constraints. Incorporating illumination into the organizer 100 also enhances its utility in field service, search-and-rescue, and emergency response applications where rapid access to properly lit equipment can be critical.

It is to be understood that embodiments may be made, other than those mentioned, and structural and functional modifications may be made without departing from the scope of the present subject matter.

It may be appreciated that reference throughout this specification to “one embodiment” or “an embodiment” or “an aspect” or features included as “may” means that a particular feature, structure or characteristic described in connection with the embodiments is included in at least one embodiment of the present subject matter. Furthermore, the particular features, structures or characteristics may be combined as suitable in one or more embodiments of the present subject matter. The previous description is provided to enable any person skilled in the art to practice the various aspects described herein. Various modifications to these aspects will be readily apparent to those skilled in the art, and the generic principles defined herein may be applied to other aspects.

Modifications to embodiments of the present subject matter described in the foregoing are possible without departing from the scope of the present subject matter as defined by the accompanying claims. Expressions such as “including”, “comprising”, “incorporating”, “have”, “is” used to describe and claim the present subject matter are intended to be construed in a non-exclusive manner, namely allowing for items, components or elements not explicitly described also to be present. Reference to the singular is also to be construed to relate to the plural.

1. A portable handheld tool organizer, comprising:
a bracket including a base plate and a wall extending upwardly from the base plate;
a pair of guide rails secured to the wall and arranged spaced apart from one another to define opposing rail surfaces; and
a tray slidably engaged with the pair of guide rails and configured to translate along a width direction of the wall between retracted and extended positions,
wherein the tray is arranged parallel to the wall and is configured to support one or more handheld power tools and manual tools in a vertical orientation when in use.

2. The organizer of claim 1, wherein the wall includes an elongated groove proximate an upper end of the wall to provide a handle structure for carrying the organizer.

3. The organizer of claim 1, wherein the pair of guide rails are disposed proximate the upper end of the wall relative to the base plate and extend along a width of the wall.

4. The organizer of claim 1, wherein each of the pair of guide rails includes a first plate attached to the wall and a second plate arranged parallel to the wall and spaced from the wall to define an elongated slot.

5. The organizer of claim 4, wherein a first one of the guide rails is L-shaped and a second one of the guide rails is inverted L-shaped, thereby defining first and second elongated slots facing each other.

6. The organizer of claim 4, wherein the tray comprises opposite longitudinal ends received in the elongated slots to slidably engage the tray to the guide rails.

7. The organizer of claim 1, wherein the tray includes a handle groove extending through the thickness of the tray proximate a lateral end of the tray to facilitate sliding the tray between the retracted and extended positions.

8. The organizer of claim 1, further comprising a second pair of guide rails secured to a side of the wall opposite the pair of guide rails and a second tray slidably supported by the second pair of guide rails, the second tray arranged parallel to the wall.

9. The organizer of claim 1, further comprising an attachment structure configured to removably mount the organizer within an interior compartment of a vehicle.

10. The organizer of claim 9, wherein the bracket is slidably mounted to the attachment structure and is vertically adjustable relative to the attachment structure to position the bracket within the compartment.

11. The organizer of claim 1, further comprising an adjustable mounting interface configured to receive tool holders or accessories at multiple selectable positions, wherein the adjustable mounting interface comprises a grid-pattern arrangement of holes, slots, or attachment points configured to allow customizable placement of tool holders.

12. A system for storing handheld power tools and manual tools within a vehicle compartment, the system comprising:
a vehicle-mounted attachment structure disposed within an interior compartment of a vehicle; and
a portable handheld tool organizer removably coupled to the attachment structure, the organizer comprising:
a bracket including a base plate and a wall extending upwardly from the base plate;
a pair of guide rails secured to the wall and arranged spaced apart from one another; and
a tray slidably supported by the pair of guide rails and configured to translate along a width direction of the wall between retracted and extended positions,
wherein the tray is arranged parallel to the wall and is configured to support one or more handheld power tools and manual tools in a vertical orientation when in use,
and wherein the bracket is removable from the attachment structure to permit portable deployment of the organizer outside the vehicle.

13. The system of claim 12, wherein the bracket is slidably engaged with the vehicle-mounted attachment structure and vertically adjustable relative to the attachment structure within the compartment.

14. The system of claim 12, wherein the wall includes an elongated groove proximate an upper end of the wall to provide a handle structure for carrying the organizer between locations.

15. The system of claim 12, wherein the base plate of the organizer defines a battery storage area configured to receive one or more rechargeable batteries.

16. The system of claim 12, wherein the organizer includes an illumination module configured to provide light during night operations at an emergency scene or job site.

17. The system of claim 12, wherein the organizer further comprises a second pair of guide rails on a side of the wall opposite the pair of guide rails and a second tray slidably supported thereby, the tray and second tray being arranged on opposite sides of the wall.

18. The system of claim 12, wherein each of the pair of guide rails comprises a first plate attached to the wall and a second plate spaced from the wall to define a slot, and wherein opposite longitudinal ends of the tray are received in respective slots.

19. The system of claim 12, further comprising an adjustable mounting interface configured to receive tool holders or accessories at multiple selectable positions, wherein the adjustable mounting interface comprises a grid-pattern arrangement of holes, slots, or attachment points configured to allow customizable placement of tool holders.
